(19) United States
(12) Patent Application Publication
(10) Pub. No.: US 2007/0172309 A1
(43) Pub. Date: Jul. 26, 2007

(54) Reconfigurable notebook holder

(76) Inventors: Kevin Wesley Witter, Dayton, OH (US); Kenneth P. Richied, Liberty Township, OH (US); Thomas J. Africa, Lebanon, OH (US)

Correspondence Address: THOMPSON HINE L.L.P.;Intellectual Property Group, P.O. BOX 8801, DAYTON, OH, 45401-8801, US

(21) Appl. No.: 11/655,485

(22) Filed: Jan. 19, 2007

Related U.S. Application Data
(60) Provisional application No. 60/760,066, filed on Jan. 19, 2006.

(51) Int. Cl. B42F 13/00

(52) U.S. Cl. 402/73

(57) ABSTRACT

A notebook holder system including a notebook holder having a cover and a panel pivotally coupled to the cover, the panel having an outer perimeter. The system further includes a bound component, wherein the panel and bound component are configured to be releasably attached together. The bound component has a plurality of pages and a binding mechanism binding the plurality of pages together. The panel and the bound component are configured such that when the bound component is releasably attached to the panel at least part of the binding mechanism is positioned outside the outer perimeter. The pages of the bound component are pivotable about the binding mechanism between a first position, wherein the pages are located adjacent to and supported by a first side of the panel, and a second position wherein the pages are located adjacent to and supported by a second opposite side of the panel.

This application claims priority to provisional Application Ser. No. 60/760,066, filed on Jan. 19, 2006, the entire contents of which are hereby incorporated by reference.

The present invention is directed to a notebook holder, and more particularly, to a notebook holder which can be configured in various positions.

### BACKGROUND

Notebook holders and the like may include a panel with a pocket formed thereon, with the pocket being configured to receive a notebook therein. Once the notebook is mounted to the notebook holder, the user can write on the pages of the notebook and use the notebook holder to carry and protect the notebook. However, in many existing notebook holders, the configuration in which the notebook can be used is limited. Accordingly, there is a need for an improved notebook holder.

### SUMMARY

In one embodiment the invention is a notebook holder which can receive a notebook therein, wherein the notebook holder can be used in various configurations. More particularly, in one embodiment the invention is a notebook holder system including a notebook holder having a cover and a panel pivotally coupled to the cover, the panel having an outer perimeter. The system further includes a bound component, wherein the panel and bound component are configured to be releasably attached together. The bound component has a plurality of pages and a binding mechanism binding the plurality of pages together. The panel and the bound component are configured such that when the bound component is releasably attached to the panel at least part of the binding mechanism is positioned outside the outer perimeter. The pages of the bound component are pivotable about the binding mechanism between a first position, wherein the pages are located adjacent to and supported by a first side of the panel, and a second position wherein the pages are located adjacent to and supported by a second opposite side of the panel.

### BRIEF DESCRIPTION OF THE DRAWINGS

FIG. 1 is a front perspective view of one embodiment of the notebook holder of the present invention, shown in its open position;

FIG. 2 is a front perspective view of the notebook holder of FIG. 1, with the notebook panel partially folded inwardly;

FIG. 3 is a front perspective view of the notebook holder of FIG. 2, with a notebook mounted thereon;

FIG. 4 is a front perspective view of the notebook holder of FIG. 3, with the notebook panel returned to its position of FIG. 1;

FIG. 5 is a front perspective view of the notebook holder of FIG. 4, with some of the pages of the notebook pivoted onto an inner surface of the notebook panel;

FIG. 6 is a front perspective view of another embodiment of the notebook holder of the present invention, shown in its closed position;

FIG. 7 is a front perspective view of the notebook holder of FIG. 6, shown in its open position;

FIG. 8 is a top view of the notebook holder of FIG. 7, with the notebook/notebook panel resting on the top panel;

FIG. 9 is a top view of the notebook holder of FIG. 8, with the retaining flap pivoted on top of the pocket panel;

FIG. 10 is a front perspective view of the notebook holder of FIG. 7, with the notebook removed;

FIG. 11 is a front perspective view of the notebook holder of FIG. 7, with the notebook/notebook panel pivoted slightly away from the storage pocket;

FIG. 12 is a front perspective view of the notebook holder of FIG. 11, with the notebook/notebook panel pivoted further away from the storage pocket;

FIG. 13 is a top view of the notebook holder of FIG. 7, with the retaining flap and top panel pivoted below the notebook/notebook panel; and

FIG. 14 is an end view of the notebook holder of FIG. 13.

### DETAILED DESCRIPTION

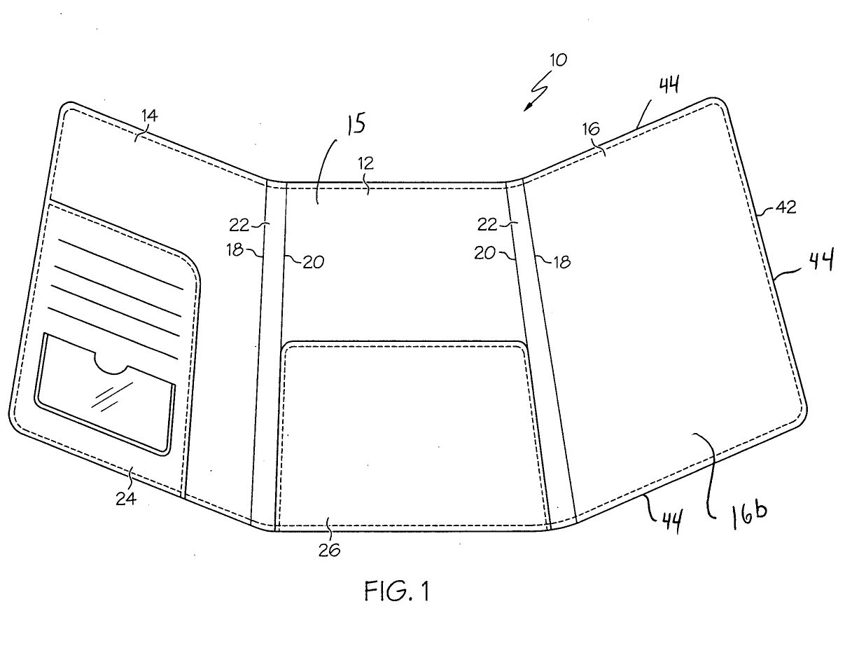

As shown in FIGS. 1-5, in one embodiment the notebook holder 10 of the present invention includes a center panel 12, an outer panel 14 and a notebook panel 16 to form a tri-fold. Each of the outer 14 and notebook 16 panels are pivotally coupled to the center panel 12 by a pair of hinge lines 18, 20, with each pair of hinge lines 18, 20 defining a generally flexible hinge portion 22 therebetween. In this manner, the outer panel 14 and notebook panel 16 can both be pivoted from their open positions shown in FIG. 1, to a closed position wherein the outer panel 14 and notebook panel 16 are generally parallel with, and lie on top of, the center panel 12.

When the notebook holder 10 is in the closed position, the outer panel 14 may be positioned between the notebook panel 16 and the center panel 12 (i.e., in the thickness direction of the notebook holder 10). Alternately, the notebook panel 16 can be positioned between the outer panel 14 and the center panel 12. In either case all panels 12, 14, 16 may be generally aligned with each other when the notebook holder 10 is closed. The center 12 and outer 14 panels (and the hinge portions 22) can constitute a cover 15 with the notebook panel 16 coupled thereto.

Each of the panels 12, 14, 16 may be generally flat and sheet-like, but with enough thickness/stiffness to be self-supporting. The panels 12, 14, 16/notebook holder 10 can be made of any of a wide variety of materials, such as plastic, paper, cardboard, vinyl, plastic (i.e., PVC) leather, cardboard covered by plastic, or the like. In the illustrated embodiment, the outer panel 14 includes an outer panel flap 24 coupled thereto (such as by stitching, adhesives or the like) along the bottom and outer edge of the flap 24. The outer panel flap 24 may include a business card holder and various slits and pockets for storing loose items therein. The center panel 12 may include a center panel flap 26 coupled thereto (i.e., by stitching, adhesives or the like) along the bottom edge of the flap 26 for trapping various components between the center panel flap 26 and the center panel 12.

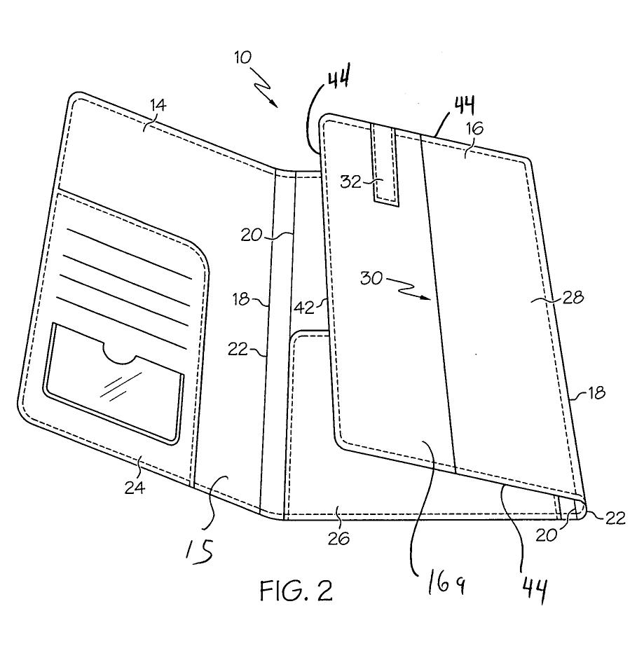

As best shown in FIG. 2, the notebook panel 16 includes a notebook panel flap 28 coupled to an outer surface of the notebook panel 16 (i.e., by stitching, adhesives or the like). The notebook panel flap 28 thereby defines a pocket 30 between the notebook panel flap 28 and the notebook panel 16. A page holder/page marker 32 may be coupled to an outer edge (the upper edge in the illustrated embodiment) of the notebook panel 16. The page holder 32 may be made of a generally flexible material, such as in one case the same material as the outer surface of the panels 12, 14, 16.

The notebook holder may be used in conjunction with a notebook 34. The notebook 34 may include a plurality of pages or sheets of paper 38 bound together by a binding mechanism 40. Each of the sheets 38 of the notebook 34 may be made of a cellulose-based or pulp-based paper that is generally water-absorbent so that the sheets 38 can be written upon by a wide variety of media, such as pens, pencils, marker, highlighters and the like. The notebook 34 may include at least one cover or generally rigid backing sheet 36 bound to the binding mechanism, wherein the cover 36 has about the same size and shape as the sheets 38.

The cover 36 may have at least one of a thickness or stiffness that is greater than the thickness/stiffness of the sheets 38 to provide protection and support, and to allow easy coupling to the pocket 30, which will be described in greater detail below. The cover 36 may be made of the same materials, and have about the same thickness and/or stiffness as the panels 12, 14, 16. The notebook 34 may have a pair of covers 36 such that the papers 38 can be positioned between the covers 36 in a thickness direction of the notebook 34 such that the covers 36 protect and cover the paper 38.

In the illustrated embodiment, the binding mechanism 40 of the notebook 34 is a wire binding mechanism, such as a coil, spiral or twin-wire binding mechanism which allows the sheets 38 and/or cover(s) 36 to pivot 360 degrees, or nearly 360 degrees, about the binding mechanism 40 without bending or creasing of the sheets 38. Accordingly such a binding mechanism may be particularly appropriate for use with the present invention. However, the binding mechanism 40 can take any of a wide variety of forms, such as an adhesive binding mechanism, staples, clasps, brackets, book-style binding mechanisms or the like. It should be understood that the term “notebook” as used herein includes any of a variety of bound components (i.e. components with a binding mechanism that binds sheets or papers together), such as notepads, notebooks and the like.

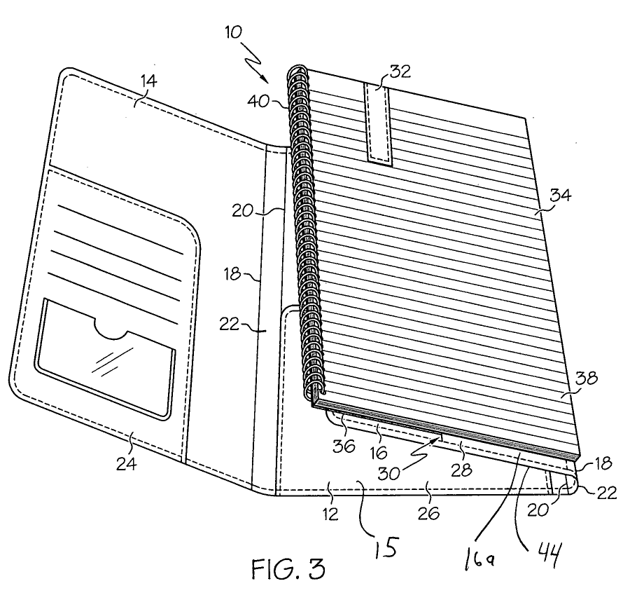

As shown in FIG. 3, the notebook 34 can be coupled to the notebook panel 16 by an attachment structure, which takes the form of the pocket 30/cover 36 in the illustrated embodiment. More particularly, in order to mount the notebook 34 to the pocket 30, a cover 36 of the notebook 34 is slid between the notebook panel 16 and notebook panel flap 28 and thereby into the pocket 30. If the notebook 34 does not include a cover 36, some of the sheets 38 can be inserted into the pocket 30. Further alternately, even if the notebook 34 does have a cover 36, the cover 36, as well as some of the sheets 38 which are not desired to be used, or which are otherwise desired to be segregated, can be slid into the pocket 30.

The attachment structure, which releasably attaches the notebook 34 and the panel 16, can take a variety of other forms besides the pocket 30/cover 36. For example, hook-and-loop fasteners (such as VELCRO®), hooks, clasps, snaps, interengaging geometries, magnets, and the like may be use to releasably attach the notebook 34 and panel 16.

When the notebook 34 is mounted to the notebook holder 10 as shown in FIG. 3, a user can write upon the sheets 38 in the configuration shown in FIG. 3. The first side or outer surface 16a of the notebook panel 16 (along with the cover 36) underlies and supports the sheets 38 such that the sheets 38 are generally parallel to the panel 16.

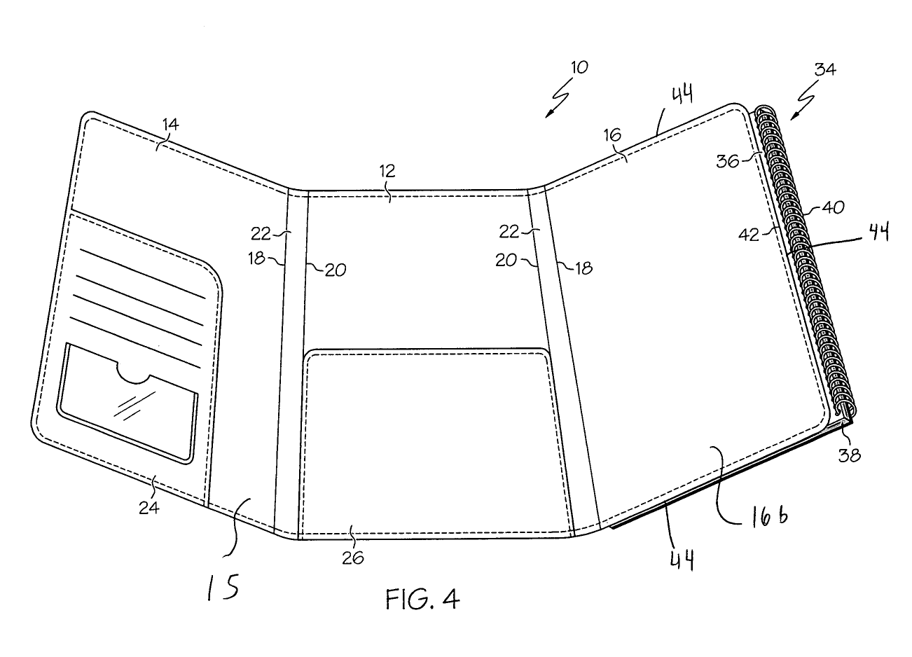

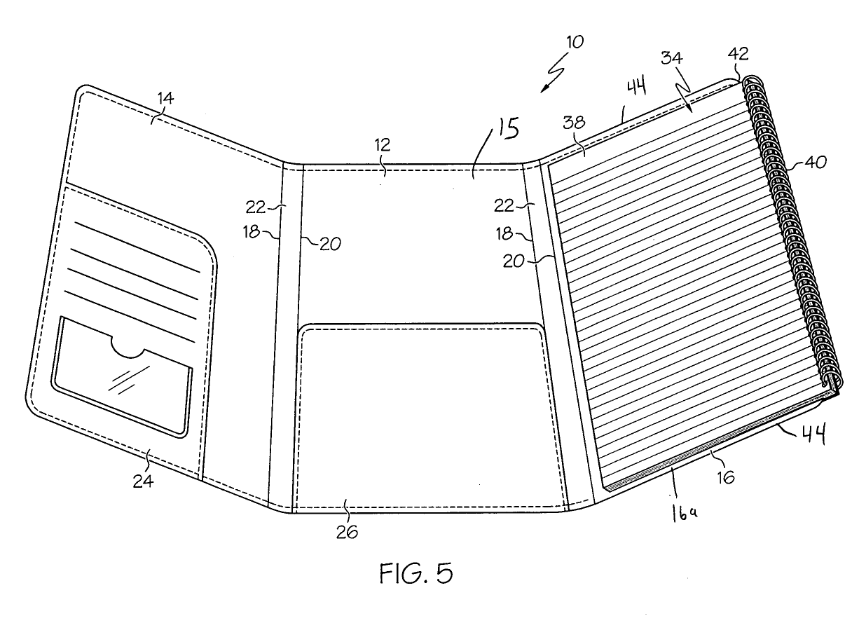

The notebook holder 10 of the present invention allows increased flexibility in the use of the notebook 34. For example, as shown in FIG. 4, the notebook panel 16 can be pivoted to its open position to expose a second side or inner surface 16b of the notebook panel 16. Next, all or selected ones of the sheets 38 of the notebook 34 can be pivoted around the binding mechanism 40 until the sheets 38 are located on, and/or supported by, the inner surface 16b of the notebook panel 16 as shown in FIG. 5 such that the sheets 38 line flat on, and parallel with, the panel 16. In this configuration, the inner surface 16b of the notebook panel 16 provides support to the pivoted sheets 38 such that a user can write on the pivoted sheets 38 and the sheets lie flat such that they can be easily written upon.

The sheets 38 are generally parallel to the underlying notebook panel 16, and are thus generally parallel relative to the notebook panel 16. Thus, the notebook holder 10 of the present invention provides great flexibility and a user can write upon the sheets 38 in two different configurations (i.e., on either side 16a, 16b of the notebook panel 16), and also allows the user to utilize the notebook holder 10 folded in different configurations.

In order to allow such pivoting of the sheets 38, the binding mechanism 40 may protrude outwardly beyond, or be spaced outwardly from, the outer edge 42 of the notebook panel 16. For example, the notebook panel 16 may have an outer perimeter 44, and at least part of the binding mechanism may be positioned outside the outer perimeter 44. In addition, by providing a binding mechanism 40 which is spaced away from the outer edge 42, the sheets 38 can lie flat upon, and be fully supported by, the notebook panel 16 when located on either side 16a, 16b thereof. Further, the binding mechanism 40 may be configured such that at least part of the binding mechanism 40 is located on either side of the notebook panel 16, which helps to ensure that the sheets 38 lie flat on the notebook panel 16 on either side thereof. In other words at least part of the binding mechanism 40 may be located on both sides of a plane defined by the notebook panel 16.

In order to utilize the notebook in the configuration shown in FIGS. 3 and 5, the notebook panel 16 should provide sufficient support to the pivoted sheets so that the sheets 38 can be easily written upon. Accordingly, the notebook 34/cover 36 and notebook panel 16/pocket 30 may be sized and configured such that the notebook panel 16 underlies at least about 80%, or at least about 90%, of the surface area of the pivoted sheets 38. In addition, the binding mechanism 40 may be desired to be located relatively close to the outer edge 42 of the notebook panel 16.

Thus, for example, it may be desired to ensure that the binding mechanism 40 is located adjacent to the outer edge 42 of the notebook panel 16 such that the binding mechanism 40 is not spaced away from the outer edge 42 by a distance greater than the width (i.e., in a left-to-right direction) of the binding mechanism 40, or such that the binding mechanism 40 is not located away from the outer edge 42 by a distance greater than one-half inch. Thus, the system 10 may be configured to provide the desired characteristics described herein when the notebook 34 is fully and securely coupled to the panel 16—i.e. in one case, when the cover 36 is fully inserted or seated into the pocket 30. In addition, the panel 16 which receives the notebook 34 thereon may be a panel having a free outer longitudinal edge 42 and not be a captured panel, such as panel 12, which lacks a free outer edge 42.

The notebook 34 may have about the same size as the notebook panel 16 to allow efficient use of the space on the panel 16. More particularly the notebook 34 may have a surface area that is within at least about 20%, or at least about 10%, of the surface area of the notebook panel 16. The notebook 34 may be sized to dispense various sizes of sheets 38, such as sheets 38 having a size of about 8.5 inches by about 11 inches, or about 4.25 inches by about 5.5 inches, or about 5 inches by about 7 inches, or about 6 inches by about 9 inches, or A3, A4 or A5 size sheets, etc.

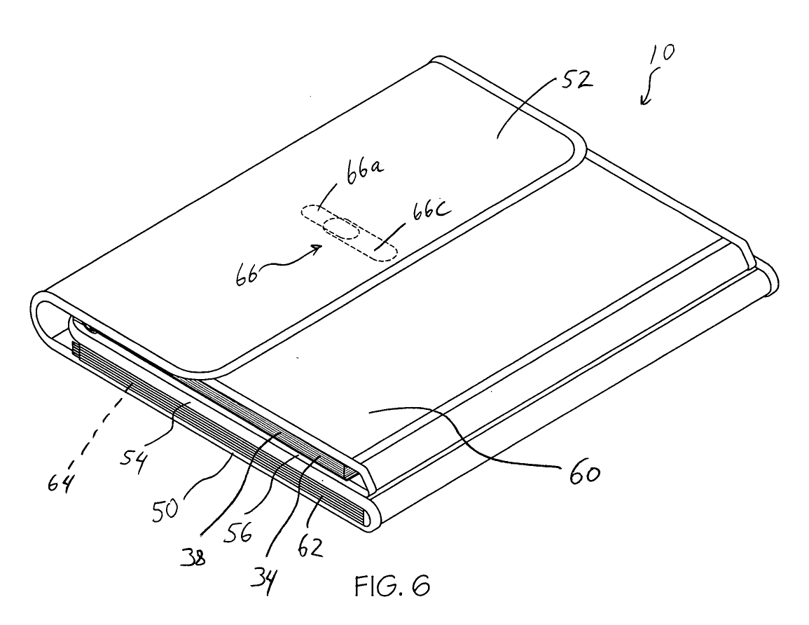

Another embodiment of the notebook holder 10 of the present invention is shown in FIGS. 6-14. In that embodiment the notebook holder includes a bottom panel 50 and a retaining flap 52 pivotally coupled to the bottom panel 50. A pocket panel 54 is pivotally coupled to the bottom panel 50, and a notebook panel 56 and top panel 60 are pivotally coupled to the pocket panel 54. In the illustrated embodiment the retaining flap 52, bottom panel 50 and pocket panel 54 are all made from a single continuous piece of material. However, if desired, the retaining flap 52, bottom panel 50 and pocket panel 54 can be made from separate pieces of material joined together. The bottom panel 50, retaining flap 52, pocket panel 54, notebook panel 56 and top panel 60 can be made of a variety of materials, such as plastic, paper, cardboard, vinyl, plastic (i.e., PVC) leather, cardboard covered by plastic, or the like. The panels and flaps 50, 52, 54, 56, 60 may be generally flat and sheet-like, but with enough thickness/stiffness to be self-supporting (i.e. retain their shape when cantilevered).

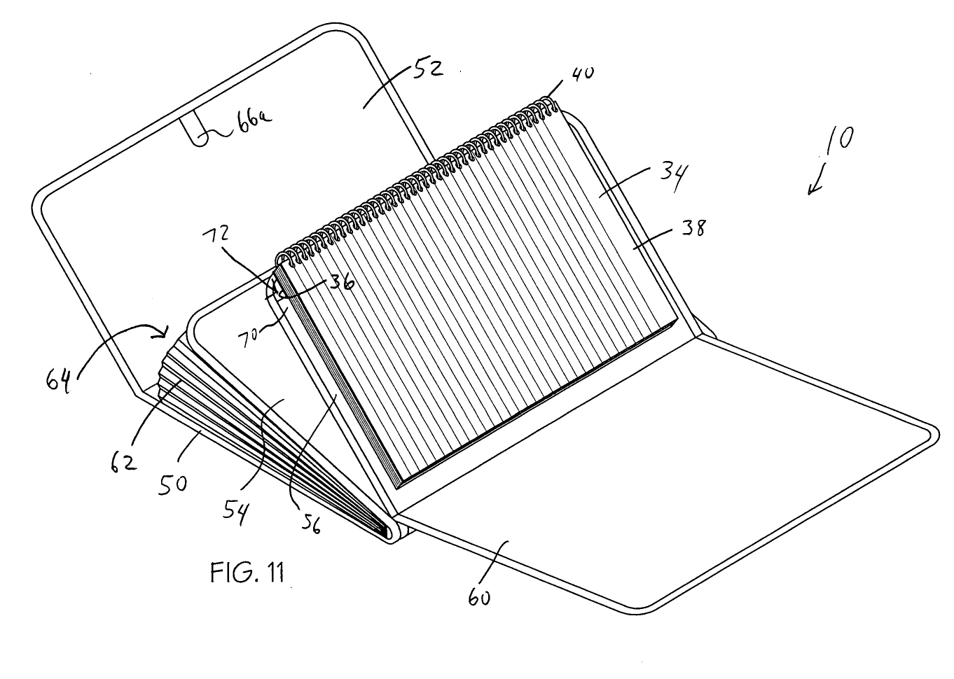

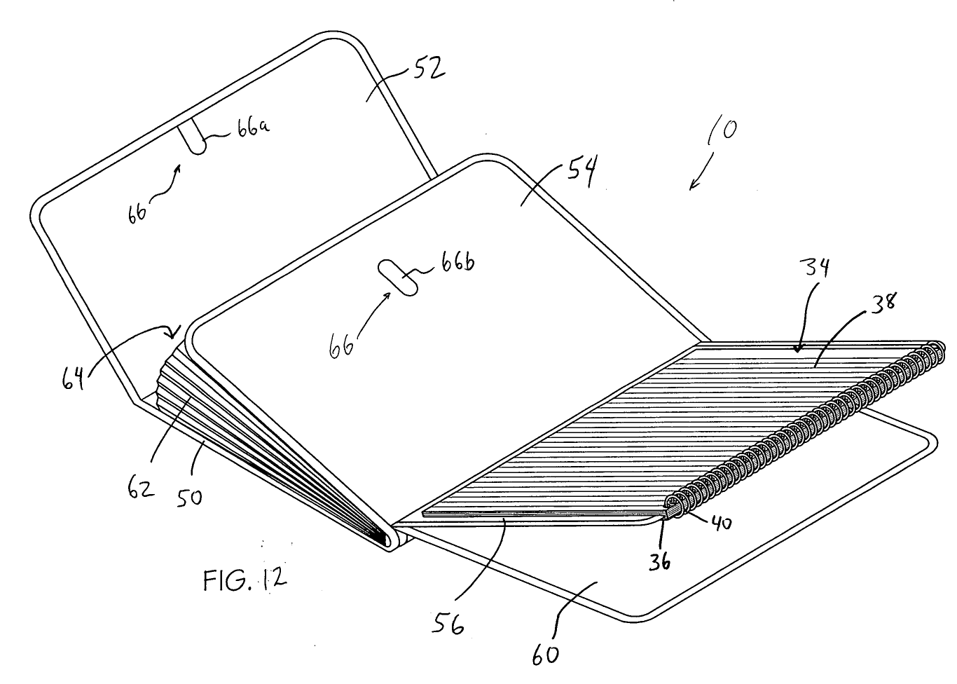

A pair of side gussets 62, such as accordion-style side gussets, are positioned between the pocket panel 54 and the bottom panel 50. In this manner a storage pocket 64 is formed between the pocket panel 54, bottom panel 50, and side gussets 62. FIGS. 11 and 12 illustrate the pocket panel 54 slightly pivoted away from the bottom panel 50 to open the mouth of the storage pocket 64.

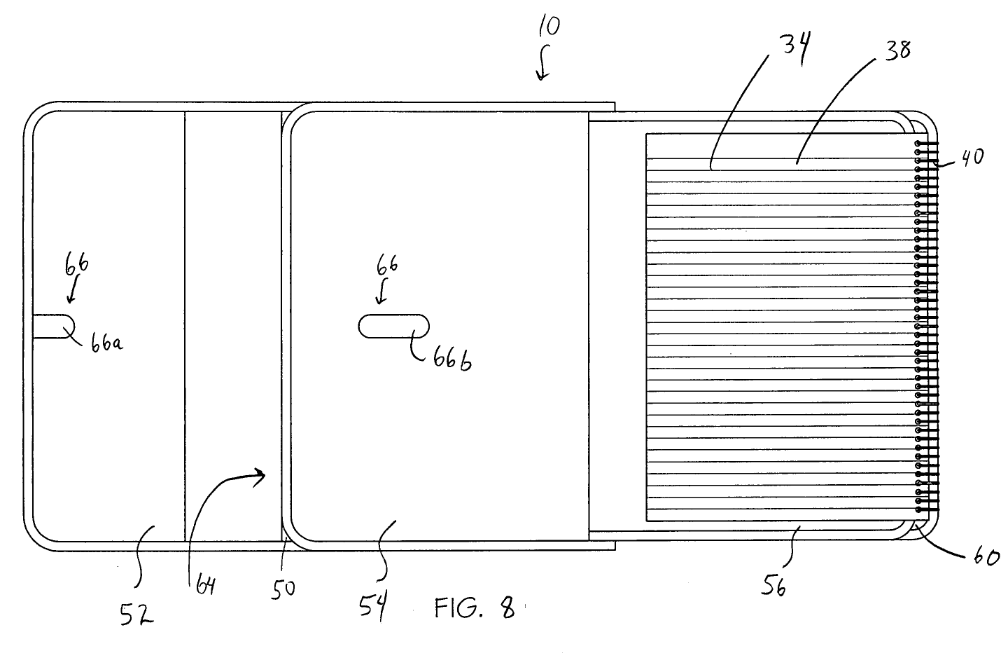

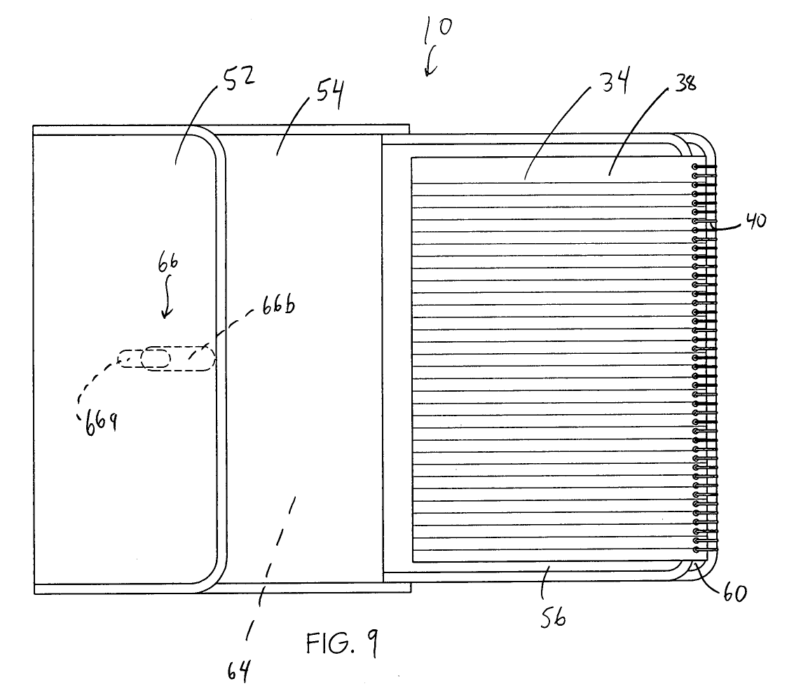

As shown in FIGS. 8 and 9 a retaining mechanism 66 may be utilized to releasably couple the retaining flap 52 and the pocket panel 54. In the illustrated embodiment the retaining mechanism 66 includes a patch 66a of hook-and-loop fastening material (such as VELCRO®) on the retaining flap 52 and a patch 66b of hook-and-loop fastening material on the pocket panel 54. The patches 66a, 66b are configured to contact each other to releasably couple the retaining flap 52 and the pocket panel 54 to generally close the storage pocket 64 (see FIG. 9). The retaining mechanism 66 can take any of a variety of other forms besides patches of hook-and-loop fastening material, such as hooks, clasps, zippers, interengaging geometries, cords, ties, straps, magnets or the like.

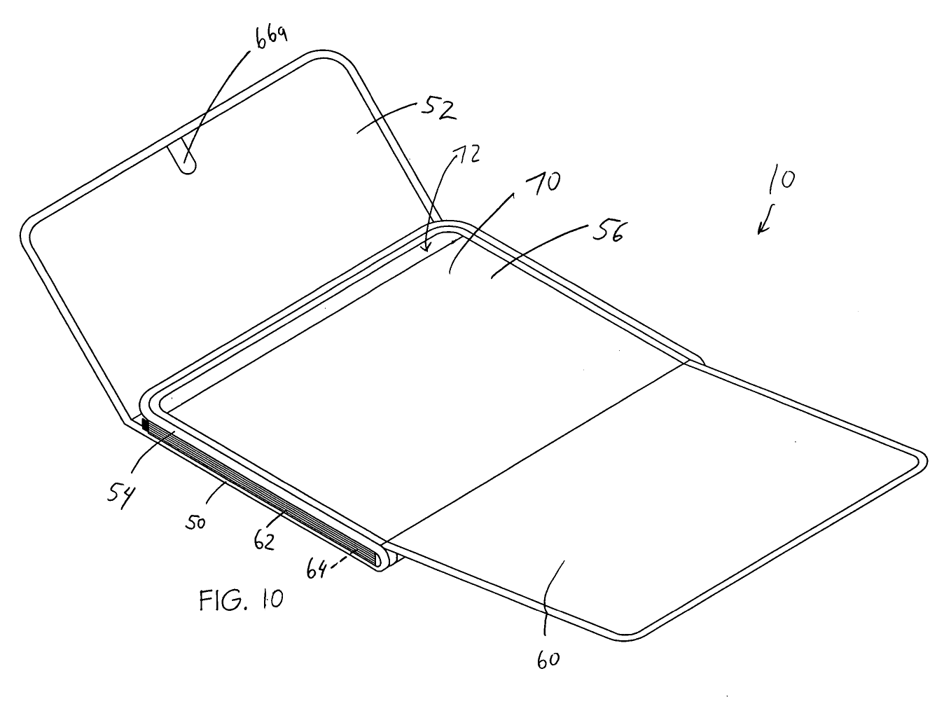

The notebook panel 56 is pivotally coupled to an upper surface of the pocket panel 54. The notebook panel 56 can be made of the same materials and function in substantially the same manner as the notebook panel 16 described above and shown in FIGS. 1-5. For example, in the illustrated embodiment the notebook panel 56 includes a notebook panel flap 70 (see FIG. 10) located thereon to form a pocket 72 on the notebook panel 16. In this manner a cover 36 of a notebook 34 can be slipped into the pocket 72 such that the notebook panel 56 removably receives the notebook 34 thereon. The opposite sides of the notebook panel 56 can then support the pages 38 of the notebook 34, as shown in FIGS. 11 and 12, to provide flexibility in the use and configuration of the notebook holder 10. The notebook panel flap 70 and pocket 72 can be positioned on either side of the notebook panel 56. The various flaps and panels 50, 52, 54, 60 and associated structures, and/or portions thereof, can be considered a cover which supports and/or receives the notebook panel 56.

The top panel 60 is pivotally coupled to the pocket panel 54 and located adjacent to the notebook panel 56, and has about the same size as the pocket panel 54, notebook panel 56 and bottom panel 50. If desired, the top panel 60 may include a device on its inner surface for retaining loose sheets of paper thereon, such as a clipboard or the like (not shown). As shown in FIG. 6, the top panel 60 can be pivoted such that the top panel 60 lies on top of the notebook panel 56 and the pocket panel 54, and such that the notebook panel 56 is positioned between the top panel 60 and the bottom panel 50 in a thickness direction of the notebook holder 10. In this configuration the top panel 60 may also be positioned on top of, and generally be aligned with, the bottom panel 50.

The retaining flap 52 can then be folded on top of the top panel 60, and a retaining mechanism 66 may be utilized to couple the retaining flap 52 and the top panel 60 and keep the notebook holder 10 in the closed position shown in FIG. 6. In the illustrated embodiment the retaining mechanism 66 includes a patch 66a of hook-and-loop fastening material (such as VELCRO®) located on the retaining flap 52 and a patch 66c of hook-and-loop fastening material located on the top panel 60. The patches 66a, 66c of hook-and-loop fastening material are configured to contact each other to releasably couple the retaining flap 52 and top panel 60 when the notebook holder 10 is in the closed position. However, the retaining mechanism 66 in this case can take any of a variety of other forms, such as hooks, clasps, zippers, interengaging geometries, cords, ties, straps, magnets or the like.

In this case it should be noted that the patch 66a of hook-and-loop fastening material located on the retaining flap 52 serves a dual purpose. For example, the patch 66a can be coupled to a corresponding patch 66b of hook-and-loop fastening material on the pocket panel 54 (as shown in FIG. 9) to close the storage pocket 64. Alternately the patch 66a can be coupled to a corresponding patch 66c of hook-and-loop fastening material on the top panel 60 (as shown in FIG. 6) to keep the notebook keeper 10 in its closed position.

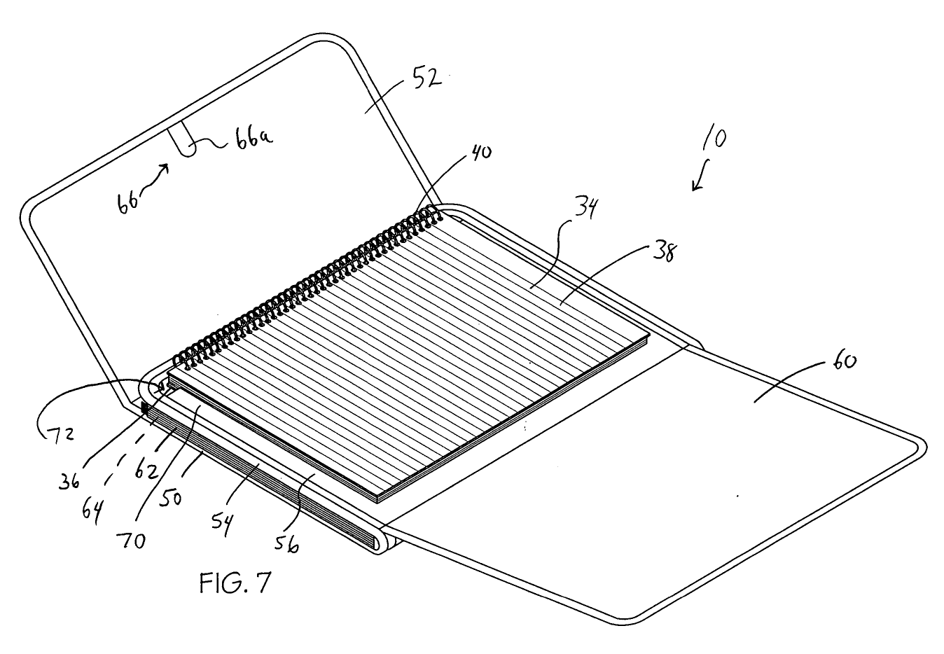

When a notebook 34 is inserted into the notebook panel pocket 72, the notebook 34/notebook panel 56 can be positioned as desired. For example, when space is available and/or it is desired to position the notebook 34 on the right hand side of the notebook holder 10, the notebook panel 56 and notebook 34 can be positioned on top of the top panel 60, as shown in FIGS. 8 and 12. Alternately, when a more compact arrangement and/or it is desired to position the notebook on the left hand side, the notebook panel and notebook can be positioned on top of the pocket panel 54/bottom panel 50, as shown in FIGS. 7 and 11. In either position pages 38 of the notebook 34 can be flipped around the binding mechanism 40 until the desired pages 38 lie on top of the notebook panel 56 such that the pages 38 can be accessed for reading, marking or the like.

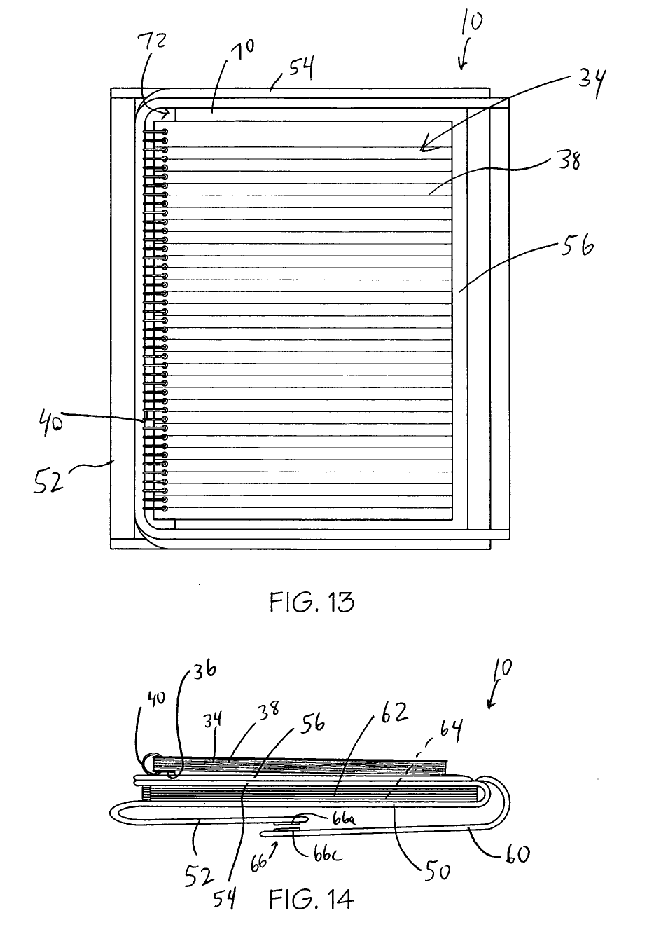

When the notebook panel 56 and notebook 34 are positioned on top of the pocket panel 54/bottom panel 50, the notebook holder 10 can assume a compact position. More particularly, as shown in FIGS. 13 and 14 the retaining flap 52 and the top panel 60 can be pivoted below the bottom panel 50, the pocket panel 52 and notebook panel 56. The retaining mechanism 66 can then be utilized to attach the retaining flap 52 and the top panel 60. More particularly, the patches 66a, 66c of hook-and-loop fastening material can be pressed together to releasably couple the retaining flap 52 and top panel 60, and to retain the notebook holder 10 in its compact state.

Thus the patches 66a, 66c of hook-and-loop fastening material are engageable while the notebook holder is in two different configurations: a first configuration as shown in FIG. 6 when the retaining flap 52 and top panel 66 are positioned above, or on a first side of, the bottom panel 50; and a second configuration as shown in FIGS. 13 and 14 when the retaining flap 52 and top panel 60 are positioned below, or on a second side of, the bottom panel 50. In this manner the notebook holder 10 is configurable in a variety of positions and configurations such that a user can position the notebook holder 10 in a manner most advantageous for the user.

While the notebook panel 16 of FIGS. 1-5 is an outer-most panel of the notebook holder 10, in the embodiment of FIGS. 6-14 the notebook panel 56 is not necessarily an outer-most panel. In other words when the notebook holder 10 of FIGS. 6-14 is fully opened the notebook panel 56 of FIGS. 6-14 may lie on top of various other panels and components. However, the other features and advantages of the notebook panel 16 of FIGS. 1-5 described above may also equally apply to the notebook panel 56 of FIGS. 6-14.

Having described the invention in detail and by reference to the preferred embodiments, it will be apparent that modifications and variations thereof are possible without departing from the scope of the invention.

What is claimed is:

1. A notebook holder system comprising:
a notebook holder including a cover and a panel pivotally coupled to said cover, said panel having an outer perimeter; and
a bound component, wherein said panel and bound component are configured to be releasably attached together, said bound component having a plurality of pages and a binding mechanism binding said plurality of pages together, wherein said panel and said bound component are configured such that when said bound component is releasably attached to said panel at least part of said binding mechanism is positioned outside said outer perimeter, and wherein said pages of said bound component are pivotable about said binding mechanism between a first position, wherein said pages are located adjacent to and supported by a first side of said panel, and a second position wherein said pages are located adjacent to and supported by a second opposite side of said panel.

2. The system of claim 1 wherein the system further includes an attachment structure for releasably attaching said panel and said bound component.

3. The system of claim 2 wherein part of said attachment structure is located on said panel and part of said attachment structure is located on said bound component.

4. The system of claim 2 wherein said attachment structure includes a pocket located on said panel, and wherein at least part of said bound component is releasably receivable in said pocket to releasably attach said bound component to said panel.

5. The system of claim 4 wherein said at least part of said bound component includes a cover that is bound to said plurality of pages and releasably receivable in said pocket, said cover having at least one of a thickness or stiffness that is greater than each of said pages.

6. The system of claim 1 wherein when said panel and said bound component are fully releasably attached together and at least part of said binding mechanism is positioned outside said outer perimeter.

7. The system of claim 1 wherein said panel is generally flat and planar and said first and second sides are opposed sides of said panel, and wherein said panel and said bound component are configured such that when said bound component is releasably attached to said panel at least part of said binding mechanism is located on both sides of said plane defined by said panel.

8. The system of claim 1 wherein said cover includes a pocket panel, and wherein said panel is directly pivotally coupled to said pocket panel.

9. The system of claim 8 wherein said cover further includes a bottom panel directly coupled to said pocket panel such that said bottom panel and said pocket panel define a storage pocket therebetween, and wherein said panel is directly coupled to an outer surface of said pocket panel.

10. The system of claim 9 wherein said cover further includes a retaining flap pivotally coupled to said bottom panel, wherein said retaining flap is pivotally coupled to said bottom panel and releasably attachable to said pocket panel to generally close said storage pocket.

11. The system of claim 8 wherein said cover further includes a top panel pivotally coupled to said pocket panel, wherein said top panel is foldable on top of said panel such that said panel is positioned between said top panel and said bottom panel in a thickness direction of said cover.

12. The system of claim 11 wherein said cover further includes a retaining flap pivotally coupled to said bottom panel, wherein said retaining flap is releasably attachable to said top panel.

13. The system of claim 12 wherein said retaining flap and said top panel are releasably attachable in a first configuration wherein said retaining flap and said top panel are positioned on a first side of said bottom panel and a second configuration wherein said retaining flap and said top panel are positioned on a second, opposite side of said bottom panel.

14. The system of claim 1 wherein said binding mechanism is a coil-wire, spiral wire or twin-wire binding mechanism such that said pages are pivotable substantially 360 degrees about said binding mechanism without creasing thereof.

15. The system of claim 1 wherein said panel and said bound component are configured such that when said bound component is releasably attached to said panel, said panel underlies at least about 80% of the surface area of said pages when said pages are in said first position, and said panel underlies at least about 80% of the surface area of said pages when said pages are in said second position.

16. The system of claim 1 wherein said panel and said bound component are configured such that when said bound component is releasably attached to said panel said binding mechanism extends along a free outer edge of said panel, and wherein said binding mechanism is not spaced away from said outer edge by a distance greater than a width of said binding mechanism.

17. The system of claim 1 wherein said when said pages are in said first position said pages are generally flat and planar, and wherein when said pages are in said second position said pages are generally flat and planar and parallel to the position when said pages are in said first position.

18. The system of claim 1 wherein said panel has a pocket and said bound component has a cover receivable in said pocket, wherein when said cover is fully seated in said pocket said cover and said pocket releasably attach said pocket and said bound component together such that at least part of said binding mechanism is positioned outside said outer perimeter.

19. A method of using a notebook holder system comprising:
accessing a notebook holder system including a panel having an outer perimeter and a bound component having a plurality of pages, said bound component including a binding mechanism binding said plurality of pages together, wherein said panel has a pocket and said bound component has a cover fully seated in said pocket to releasably attach said pocket and said bound component together such that at least part of said binding mechanism is positioned outside said outer perimeter; and
pivoting said pages of said bound component about said binding mechanism between a first position, wherein said pages are located adjacent to and supported by a first side of said panel, and a second position wherein said pages are located adjacent to and supported by a second opposite side of said panel.

20. A notebook holder system comprising:
a cover including a generally flat and planar panel pivotally positioned therein, said panel having a pocket located thereon, said panel having an outer perimeter and first and a second opposed sides, each side being defined by said outer perimeter of said panel extending therearound; and
a bound component having a plurality of pages and being configured such that at least part of said bound component is receivable in said pocket to releasably couple said panel and said bound component, wherein said panel and said bound component are configured such that when said panel and bound component are coupled together at least part of said bound component is positioned outside said outer perimeter, and wherein said pages are pivotable about said binding mechanism between a first position, wherein said pages are located adjacent to and supported by said first side, and a second position wherein said pages are located adjacent to and supported by said second side.

21. A notebook holder system comprising:
a notebook holder including a panel having an outer perimeter; and
a bound component, wherein said panel and bound component are configured to be releasably attached together, said bound component having a plurality of pages and a binding mechanism binding said plurality of pages together, wherein said panel and said bound component are configured such that when said bound component is releasably attached to said panel at least part of said binding mechanism is positioned outside said outer perimeter, and wherein said pages of said bound component are pivotable about said binding mechanism between a first position, wherein said pages are located adjacent to and supported by a first side of said panel, and a second position wherein said pages are located adjacent to and supported by a second side of said panel.
